(19) United States
(12) Patent Application Publication
(10) Pub. No.: US 2007/0266876 A1
(43) Pub. Date: Nov. 22, 2007

(54) Printed article of metallized appearance

(76) Inventors: Michael G. Reindl, West Bend, WI (US); Michael D. McElhatton, Kewaskum, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/438,245

(22) Filed: May 22, 2006

(51) Int. Cl. B41F 33/00

(52) U.S. Cl. 101/483

(57) ABSTRACT

A printed article of metallized appearance, and method therefor, includes a matrix of dots on a substrate separated by spaces therebetween, and a matrix of metallization. A three dimensional printed article contoured profile implementation is enabled without the necessity of stretchable metallization.

### BACKGROUND AND SUMMARY

The invention relates to printed articles having a metallized appearance.

Printed articles having a metallized appearance are known in the prior art. A metallization layer is transferred, e.g. by roll leaf or hot stamping, to a substrate before or after printing of one or more ink layers. Challenges arise when it is desired to have a stretchable structure, e.g. to stretch around a non-rectilinear contour or bend of a three dimensional contoured article. The substrate and the printed ink layers are typically stretchable. However, the metallization layer is typically not stretchable, except for some inordinately expensive stretchable metallization materials.

The present invention arose during continuing development efforts directed toward the above challenges, and toward providing a cost-effective solution.

### BRIEF DESCRIPTION OF THE DRAWINGS

FIG. 1 is a side view showing a manufacturing step in producing an article in accordance with the invention.

FIG. 2 is a top view of a portion of FIG. 1.

FIG. 3 is an isometric view of an article constructed in accordance with the invention.

FIG. 4 is an isometric view of another article constructed in accordance with the invention.

FIG. 5 is an enlarged view of a portion of FIG. 3.

### DETAILED DESCRIPTION

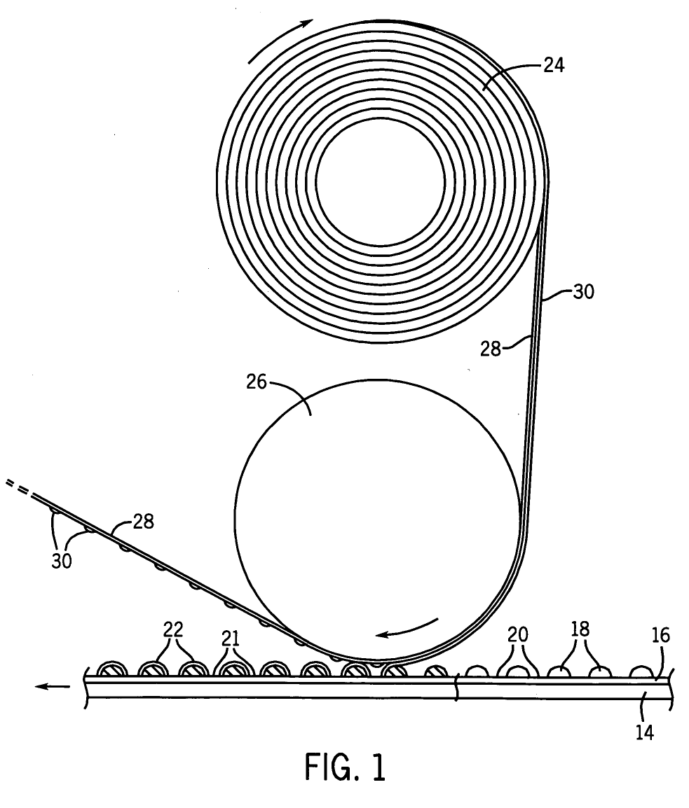

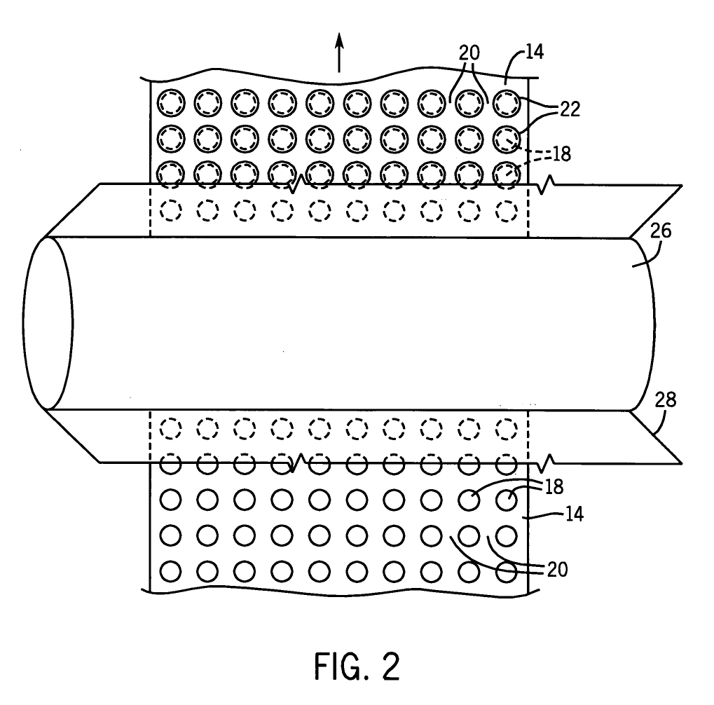

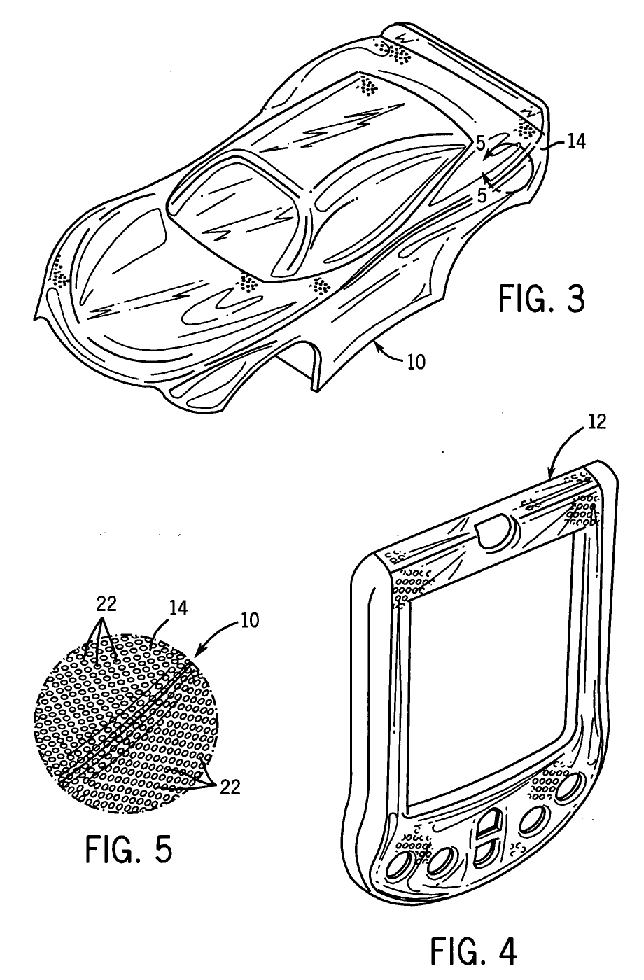

FIG. 1 shows a manufacturing step in producing a printed article of metallized appearance, for example as shown in FIG. 3 at toy race car shell 10, and as another example as shown in FIG. 4 at bezel or face plate 12 such as for handheld electronic devices, such as handheld video games, cell phones, palm pilots, and PDA's (personal digital assistant). A substrate 14, FIG. 1, is initially provided, which may be a clear or opaque plastic, e.g. styrene, ABS, acrylic, polyester, polycarbonate, vinyl, urethane, and the like, preferably having a thickness in the range of 0.005 to 0.06 inch. A layer 16 is printed on the substrate, and then a matrix of ink dots 18 is printed thereon, the dots being separated by spaces 20 therebetween. The printing steps may be performed by offset printing, silk screen printing, digital printing, flexography, rotogravure printing, roller coating, or pad printing. Printed layer 16 may provide an image layer if desired. In an alternative embodiment, printed layer 16 is omitted, and ink dots 18 are printed directly on substrate 14, with no ink layer therebetween. A matrix of metallization dots 22 are provided on the ink dots by transferring metallization thereto, e.g. by hot stamping, or by roll leafing as shown from metallization foil roll 24 applied by roller 26. The matrix of ink dots 18 are provided by foil-receptive ink dots separated by foil-non-receptive spaces 20 therebetween, e.g. by providing the printed ink dots with a higher metallization transfer coefficient (e.g. softer) than the spaces 20 therebetween. The matrix of metallization dots 22 is provided by metallization foil layer 28 transferred to foil-receptive ink dots 18 and not to foil-non-receptive spaces 20 therebetween, whereby to provide metallization dots 22 on ink dots 18, and leave remaining non-transferred metallization portions 30 on layer 28, FIGS. 1, 2. The right hand portion of FIG. 1 shows ink dots 18 in elevation, and the left hand portion of FIG. 1 shows the ink dots in cross-section. After the noted metallization transfer, one or more additional ink or coating layers may be printed on the substrate over the metallization matrix, and the substrate is then formed, e.g. hot or cold, using vacuum forming, bladder forming, pressure forming, matched male/female tool forming, or the like, to the desired three dimensional shape, e.g. FIGS. 3, 4, providing a printed article of contoured metallized appearance having a three dimensional contoured profile or topography. In further alternatives, one or more additional ink or coating layers may be printed on the substrate under the metallization matrix and/or under the substrate, i.e. on the surface of the substrate opposite dots 18, e.g. a tinted layer or the like.

The noted three dimensional printed article of contoured metallized appearance includes the noted matrix of ink dots 18 printed on the substrate including along non-rectilinear contours of the noted three dimensional contoured profile, and a matrix of metallization dots 22 on the ink dots 18. Ink dots 18 with metallization dots 22 thereon are separated by spaces 20 therebetween along the substrate which spaces and substrate stretch, including along the noted non-rectilinear contours, to alleviate the necessity of metallization at metallization dots 22 having to stretch along such non-rectilinear contours, thus alleviating cracking of the metallization otherwise occurring at non-rectilinear contours. The spaced dot structure and appearance is readily visible close-up, FIG. 5, but from a distance appears as a metallized surface, FIG. 3. The metallization layer on the matrix of ink dots 18 is actually a non-continuous metallization layer comprising non-stretchable metallization dots 22 separated by non-metallized gaps 21 aligned with spaces 20 between ink dots 18. The surface area ratio of metallization dots 22 to non-metallized stretchable gaps 21 along the surface of the substrate is preferably in the range of 30% to 70%.

In one embodiment, a printed layer at 16 is provided on the substrate and has a plurality of printed dots thereon of a first metallization transfer coefficient providing the noted ink dots 18, and leaves the remainder of layer 16 or the substrate exposed at spaces or gaps between such printed dots to provide spaces 20 between ink dots 18, wherein the noted unprinted spaces have a second metallization transfer coefficient (e.g. harder) than the noted first metallization transfer coefficient (e.g. softer), to facilitate transfer of metallization to ink dots 18 and not to spaces 20 therebetween. In another embodiment, a printed layer is provided at 16 on the substrate and has a plurality of printed dots of a first metallization transfer coefficient providing ink dots 18, and having printed spaces between the printed dots to provide the noted spaces 20 between ink dots 18, with the noted printed spaces having a second metallization transfer coefficient less than the noted first metallization transfer coefficient, to facilitate transfer of metallization to ink dots 18 and not to spaces 20 therebetween. Dots 18 and 22 may be circular, rectangular, oval, triangular, diamond-shapes, or other shapes. The dots may be provided in various patterns, and may leave various openings or windows or gaps where there are no dots. During the noted forming to a three dimensional article, the substrate stretches, but the metallized foil at dots 22 does not stretch. It has been found that the present dot construction eliminates the need to use the above noted expensive stretchable metallization material. In the present system, non-stretchable metallization at 22 sits on small islands of ink 18, and the distance or space 20 between islands 18 grows and stretches, but the dot 18 with metallization foil 22 thereon does not stretch, thus avoiding cracking otherwise occurring when attempting to stretch non-stretchable metallization material.

In further alternatives, the noted foil-receptors may be reversed, for example such that a matrix of dots is provided on the substrate, the dots being separated by spaces therebetween, and a matrix of metallization is provided along the spaces 20 in gaps 21 and not on dots 18. Thus, a printed article of metallized appearance is provided including a substrate, a matrix of dots on the substrate, the dots being separated by spaces therebetween, and a matrix of metallization along one of a) the set of dots and b) the set of spaces. In the preferred embodiment, the matrix of dots is a matrix of foil-receptive ink dots printed on the substrate with foil-non-receptive spaces 20 therebetween, and the matrix of metallization is a matrix of metallization dots on the ink dots. In the noted reversed alternative, the areas at dots 18 are foil-non-receptive, and the spaces 20 therebetween are foil-receptive, and the matrix of metallization is provided by metallization along spaces 20 and not along dots 18. In the noted latter alternative, the areas at dots 18 may be printed with foil-non-receptive ink, with the spaces 20 therebetween being a printed matrix of foil-receptive ink. Alternatively, the areas at dots 18 may be left unprinted or otherwise expose a substrate or surface non-receptive to the metallization foil. In the noted three dimensional printed article of contoured metallized appearance including a substrate of three dimensional contoured profile, both the matrix of dots 18 and the spaces 20 therebetween are along the non-rectilinear contours of the profile, and the matrix of metallization is along one of a) the set of dots 18 and b) the set of spaces 20, and the other of a) the set of dots 18 and b) the set of spaces 20 are stretchable including along the noted non-rectilinear contours of the profile. One of a) the set of dots 18 and b) the set of spaces 20 comprise foil-receptive areas, and the other of a) the set of dots 18 and b) the set of spaces 20 comprise foil-non-receptive areas, and the matrix of metallization is provided by a metallization foil layer transferred to the foil-receptive areas and not to the foil-non-receptive areas.

In the foregoing description, certain terms have been used for brevity, clearness, and understanding. No unnecessary limitations are to be implied therefrom beyond the requirement of the prior art because such terms are used for descriptive purposes and are intended to be broadly construed. The different configurations, methods, and systems described herein may be used alone or in combination with other configurations, methods and systems. It is to be expected that various equivalents, alternatives and modifications are possible within the scope of the appended claims.

What is claimed is:

1. A printed article of metallized appearance comprising a substrate, a matrix of dots on said substrate, said dots being separated by spaces therebetween, and a matrix of metallization along one of a) the set of said dots and b) the set of said spaces.

2. The printed article according to claim 1 wherein said matrix of dots comprises a matrix of ink dots printed on said substrate.

3. The printed article according to claim 2 wherein said matrix of metallization comprises a matrix of metallization dots on said ink dots.

4. A three dimensional printed article of contoured metallized appearance comprising a substrate of three dimensional contoured profile, a matrix of dots printed on said substrate including along non-rectilinear contours of said profile, said dots being separated by spaces therebetween including along said non-rectilinear contours of said profile, a matrix of metallization along one of a) the set of said dots and b) the set of said spaces, the other of a) the set of said dots and b) the set of said spaces being stretchable including along said non-rectilinear contours of said profile, to alleviate the necessity of metallization having to stretch along said non-rectilinear contours of said profile, thus alleviating cracking of said metallization otherwise occurring at said non-rectilinear contours of said profile.

5. The three dimensional printed article according to claim 4 wherein said matrix of dots comprises a matrix of ink dots printed on said substrate including along said non-rectilinear contours of said profile, said matrix of metallization comprises a matrix of metallization dots on said ink dots, wherein said ink dots with said metallization dots thereon are separated by said spaces therebetween along said substrate which stretch, including along said non-rectilinear contours of said profile, to alleviate the necessity of metallization at said metallization dots having to stretch along said non-rectilinear contours of said profile.

6. The three dimensional printed article according to claim 5 comprising a non-continuous metallization layer on said matrix of ink dots, said non-continuous metallization layer comprising non-stretchable said metallization dots separated by non-metallized gaps aligned with said spaces between said ink dots.

7. The three dimensional printed article according to claim 6 wherein the surface area ratio of said metallization dots to said non-metallized gaps along the surface of said substrate is in the range of 30% to 70%.

8. The three dimensional printed article according to claim 4 wherein one of a) the set of said dots and b) the set of said spaces comprises foil-receptive areas, and the other of a) the set of said dots and b) the set of said spaces comprises foil-non-receptive areas, and said matrix of metallization comprises a metallization foil layer transferred to said foil-receptive areas and not to said foil-non-receptive areas.

9. The three dimensional printed article according to claim 5 wherein said matrix of ink dots comprises foil-receptive ink dots separated by foil-non-receptive spaces therebetween, and said matrix of metallization dots comprises a metallization foil layer transferred to said foil-receptive ink dots and not to said foil-non-receptive spaces therebetween.

10. The three dimensional printed article according to claim 5 comprising a printed layer on said substrate, said printed layer having a plurality of printed dots of a first metallization transfer coefficient providing said ink dots, and leaving said substrate exposed at unprinted spaces between said printed dots to provide said spaces between said ink dots, said unprinted spaces having a second metallization transfer coefficient less than said first metallization transfer coefficient, to facilitate transfer of metallization to said ink dots and not to said spaces therebetween.

11. The three dimensional printed article according to claim 5 comprising a printed layer on said substrate, said printed layer having a plurality of printed dots of a first metallization transfer coefficient providing said ink dots, and having printed spaces between said printed dots to provide said spaces between said ink dots, said printed spaces having a second metallization transfer coefficient less than said first metallization transfer coefficient, to facilitate transfer of metallization to said ink dots and not to said spaces therebetween.

12. A method for making a printed article of metallized appearance comprising providing a substrate, printing a matrix on said substrate comprising dots separated by spaces therebetween, and forming a matrix of metallization on said printed matrix including metallization along one of a) the set of said dots and b) the set of said spaces.

13. The method according to claim 12 comprising printing said matrix on said substrate by printing a matrix of ink dots on said substrate.

14. The method according to claim 13 comprising forming said matrix of metallization by forming a matrix of metallization dots on said ink dots.

15. The method according to claim 12 comprising forming said substrate including said printed matrix and said matrix of metallization into a three dimensional printed article of contoured metallized appearance having a three dimensional contoured profile, such that said matrix of dots on said substrate includes dots along non-rectilinear contours of said profile, said dots being separated by said spaces therebetween including along said non-rectilinear contours of said profile, said matrix of metallization being along one of a) the set of said dots and b) the set of said spaces, the other of a) the set of said dots and b) the set of said spaces being stretchable including along said non-rectilinear contours of said profile, to alleviate the necessity of metallization having to stretch along said non-rectilinear contours of said profile, thus alleviating cracking of said metallization otherwise occurring at said non-rectilinear contours of said profile.

16. The method according to claim 15 comprising printing said matrix on said substrate by printing a matrix of ink dots on said substrate separated by said spaces therebetween, forming said matrix of metallization by forming a matrix of metallization dots on said ink dots, forming said substrate including said matrix of ink dots and said matrix of metallization dots into said three dimensional printed article of contoured metallized appearance having said three dimensional contoured profile, such that said matrix of ink dots printed on said substrate includes ink dots along said non-rectilinear contours of said profile, including said metallization dots on said ink dots at said non-rectilinear contours of said profile, wherein said ink dots with said metallization dots thereon are separated by said spaces therebetween along said substrate which stretch, including along said non-rectilinear contours of said profile, to alleviate the necessity of metallization at said metallization dots having to stretch along said non-rectilinear contours of said profile, thus alleviating cracking of said metallization otherwise occurring at said non-rectilinear contours of said profile.

17. The method according to claim 16 comprising forming a non-continuous metallization layer on said matrix of ink dots, said non-continuous metallization layer comprising non-stretchable said metallization dots separated by non-metallized gaps aligned with said spaces between said ink dots.

18. The method according to claim 15 comprising providing one of a) the set of said dots and b) the set of said spaces as foil-receptive areas, and providing the other of a) the set of said dots and b) the set of said spaces as foil-non-receptive areas, and providing said matrix of metallization by transferring metallization from a metallization foil to said foil-receptive areas and not to said foil-non-receptive areas.

19. The method according to claim 16 comprising providing said matrix of ink dots comprising foil-receptive ink dots separated by foil-non-receptive spaces therebetween, and providing said matrix of metallization dots by transferring metallization from a metallization foil to said foil-receptive ink dots and not to said foil-non-receptive spaces therebetween.

20. The method according to claim 16 comprising printing a layer on said substrate having a plurality of printed dots of a first metallization transfer coefficient providing said ink dots, and leaving said substrate exposed at unprinted spaces between said printed dots to provide said spaces between said ink dots, said unprinted spaces having a second metallization transfer coefficient less than said first metallization transfer coefficient, and transferring metallization from a metallization foil to said ink dots and not to said spaces therebetween as facilitated by said first and second different metallization transfer coefficients.

21. The method according to claim 16 comprising printing a layer on said substrate having a plurality of printed dots of a first metallization transfer coefficient providing said ink dots, and having printed spaces between said printed dots to provide said spaces between said ink dots, said printed spaces having a second metallization transfer coefficient less than said first metallization transfer coefficient, and transferring metallization from a foil to said ink dots and not to said spaces therebetween as facilitated by said first and second different metallization transfer coefficients.
